(19) United States
(12) Patent Application Publication
(10) Pub. No.: US 2014/0272258 A1
(43) Pub. Date: Sep. 18, 2014

(54) RECYCLED POLYSTYRENE SHEET

(71) Applicant: Michael J. SMITH, Northville, MI (US)

(72) Inventor: Michael J. SMITH, Northville, MI (US)

(21) Appl. No.: 13/840,934

(22) Filed: Mar. 15, 2013

(51) Int. Cl. B41M 5/50; B29C 47/00

(52) U.S. Cl. CPC B41M 5/508; B29C 47/0069; B29C 47/0066
USPC 428/80; 428/195.1; 264/132; 264/37.32; 156/244.16; 264/45.4

(57) ABSTRACT

The present invention relates to a recycled polystyrene foamed sheet apparatus for displaying images and a method of making the same.

### FIELD OF THE INVENTION

This disclosure relates to a polystyrene sheet that can be manufactured from recycled materials, and further relates to providing images on the polystyrene sheet.

### BACKGROUND

Digital photography is exploding with the refinement of digital cameras and portable smartphone devices with integrated picture taking capability. This has enabled many more consumers to take digital photos due to ease of use and portability. As digital photography has become a mainstream hobby to capture not only family moments but everything from sporting events, travel, and food, demand has increased substantially for inexpensive apparatuses which can display digital photos. The traditional approach of printing on paper and framing is deficient as the image is often degraded and the glass frames are not only heavy and difficult to affix to walls, but very expensive especially in large sizes. In addition, glass frames can impair the image due to light reflections, smudges, and general glass tints. Most consumers presently turn to canvas apparatuses whereby a canvas sheet is wrapped around a wood frame, however such apparatuses can be costly especially when ordered in large sizes. Furthermore, these canvas boards need to be bleached to obtain a white surface for improved photo clarity. Finally, these canvas prints are labor intensive and typically need to be ordered and manufactured and are not readily available at printing shops for immediate printing and consumer handover.

Accordingly, there is a need in the current digital photo market for a new method of displaying these photos. Polystyrene is one of the most widely used plastics in the world and is produced on a scale of several billion kilograms per year. However, being chemically inert and resistant to acids and bases discarded polystyrene can take hundreds of years to biodegrade. Therefore, polystyrene is the focus of much controversy as being a major form of litter for the environment, particularly along shores and waterways. In the ocean specifically, polystyrene is a major component of plastic debris where it is hazardous to marine life. As such, there have been many initiatives started to reduce polystyrene formation. However, as it is so inexpensive to produce many users are hesitant to look to alternatives.

Furthermore, polystyrene is generally not accepted in curbside collection recycling programs and when it is collected, it is not separated and recycled. This lack of recycling is typically due to lack of incentive of recycling companies to invest in the expensive compactors and logistical systems required for transportation. Specifically, the low density of polystyrene results in very large volume per mass ratio, and large polystyrene consumers discard such large amounts that the logistics of transporting it to recycling facilities would be challenging and expensive.

As such, there exists a need for incentives to encourage polystyrene recycling and products formed of polystyrene that are appealable to everyday consumers and can be easily manufactured at the site of original discard.

### SUMMARY OF THE INVENTION

Polystyrene sheets can be formed of recycled or other polystyrene foam. These sheets can be cut into various sizes for image display, and can have a bright white coloring which results in production of crisp clean images. The sheets may also be penetrated on the borders thus allowing for decoration with items that may enhance the image viewing experience.

Exemplary embodiments of this invention include but are not limited to:

(1) A process of producing a polystyrene sheet formed of recycled polystyrene, said process comprising: densifying discarded EPS to produce densified expanded polystyrene, converting the densified expanded polystyrene into pellets, extruding the pellets into a sheet, cutting the sheet to a desired size, and affixing an image to at least one surface of the sheet.

(2) The method of paragraph (1) above, wherein the waste produced when the sheet is cut is recycled back into the discarded expanded polystyrene.

(3) The method of paragraph (1) above, wherein the extruder is adjusted to obtain a thickness of the finished sheet from 1 mm to 25 mm.

(4) The method of paragraph (1) above, wherein the image is affixed with an inkjet printer or a dye-sublimation printer.

(5) The method of paragraph (1) above, wherein the sheet is further decorated on at least one surface thereof with a decorative material.

(6) The method of paragraph (5) above, wherein the decorative material is at least one selected from the group consisting of an edge band, a decorative garland, a rope, a cord, an LED light strip, a large upholstery tack, a decorative ribbon, a fishing lure, or souvenir pins with logos representing professional or college sports teams.

(7) The method of paragraph (1) above, wherein the sheet may be died with a pigment and cured by UV light.

(8) A process of producing a polystyrene sheet formed of recycled polystyrene, said process comprising: densifying discarded expanded polystyrene to produce densified expanded polystyrene, breaking down the densified EPS to form pellets, feeding the pellets into an extruder, heating the pellets beyond its melting point to form plasticized expanded polystyrene, wherein during said heating a white color master batch is added to the pellets, feeding the plasticized EPS through a screen to form secondary pellets, feeding the secondary pellets into a sheet extruder with a sheet die to form an expanded thermoplastic sheet.

(9) The method of paragraph (8) above, wherein a blowing agent is added.

(10) The method of paragraph (8) above, wherein the sheet is further decorated on at least one surface thereof with a decorative material.

(11) A polystyrene sheet formed by the process of paragraph (1) above.

(12) A polystyrene sheet formed by the process of paragraph (8) above.

(13) A polystyrene sheet formed of recycled polystyrene, said polystyrene sheet being affixed with at least one image on a primary surface thereof.

(14) The polystyrene sheet formed of recycled polystyrene according to paragraph (13) above, wherein the image may wrap from the primary surface to a secondary surface.

(15) The polystyrene sheet formed of recycled polystyrene according to paragraph (13) above, wherein a decorative material is affixed to at least one surface of the polystyrene sheet.

(16) The polystyrene sheet formed of recycled polystyrene according to paragraph (13) above, wherein said decorative material is affixed with at least one item selected from the group consisting of adhesive, a push pin, a staple, a nail, or tape.

(17) The polystyrene sheet formed of recycled polystyrene according to paragraph (13) above, wherein the polystyrene sheet is cut into a non-rectangular shape.

(18) The polystyrene sheet formed of recycled polystyrene according to paragraph (13) above, wherein the recycled polystyrene is UV cured.

(19) The polystyrene sheet formed of recycled polystyrene according to paragraph (13) above, wherein the recycled polystyrene is expanded polystyrene.

(10) The polystyrene sheet formed of recycled polystyrene according to paragraph (13) above, wherein the recycled polystyrene is expanded polystyrene comprises mixtures of other recycled materials and other forms of expanded polystyrene and Polypropylene

Additional objects, aspects and embodiments of the invention are found in the following detailed description of the invention.

### BRIEF DESCRIPTION OF THE DRAWINGS

A more complete appreciation of this disclosure and many of the attendant features thereof will be readily obtained as the same becomes better understood by reference to the following detailed description when considered in connection with the accompanying drawings, wherein:

FIG. 1 illustrates an exemplary process of manufacture of a recycled polystyrene sheet with an image provided thereon.

FIG. 2 illustrates a recycled polystyrene sheet provided with an image thereon.

FIG. 3 illustrates a recycled polystyrene sheet provided with an image thereon and decoration on surfaces thereof with decorative material.

FIG. 4 illustrates an exemplary processing system in accordance with this disclosure that can be implemented using a microprocessor or its equivalent, such as a central processing unit (CPU) and/or at least one application specific processor ASP (not shown).

### DETAILED DESCRIPTION

As established above, there is a need in the current digital photo market for a new method of displaying these photos. In addition, there exists a need for incentives to encourage polystyrene recycling and products formed of polystyrene that are appealable to everyday consumers and can be easily manufactured at the site of original discard. These needs are met by the present invention of recycled polystyrene sheets that can be easily produced, are inexpensive, and have a naturally white color that does not need to be chemically treated prior to printing.

Polystyrene is a long chain hydrocarbon wherein alternating carbon centers are attached to phenyl groups. Polystyrene's chemical formula is (C₈H₈)n. Since the molecules in polystyrene are long hydrocarbon chains that consist of thousands of tiny atoms, the total attractive force between the molecules is large. When heated, the chains take on a higher degree of conformation and can slide past each other. This intermolecular weakness confers flexibility and elasticity when heated above its glass transition temperature (approximately 90° C.).

In the polymerization of polystyrene, the carbon-carbon pi bond (in the vinyl group) is broken and the new carbon-carbon single (sigma) bond is formed attaching another styrene monomer to the chain. The sigma bond is much stronger than the pi bond and thus it is very difficult to de-polymerize polystyrene. A polystyrene chain typically comprises a few thousand monomers and the commercially produced polystyrene is atactic, wherein the phenyl groups are randomly distributed on both sides of the polymer chain. This random positioning prevents the chains from aligning with sufficient regularity to achieve any crystallinity.

Polystyrene is commonly injection molded, extruded, foamed or expanded. Polystyrene can also be in an expanded composite form with cellulose and/or starch. Expanded polystyrene (EPS) as discussed in this specification is a rigid, tough, closed cell foam. It is typically white in color and formed of pre-expanded polystyrene beads. EPS is used for a large number of commercial products including disposable trays, plates, bowls, cups, carry-out food packaging, molded sheets for building insulation, and packaging materials. Polystyrene foams are produced using blowing agents that form bubbles and expand the foam. In expanded polystyrene, the blowing agents can be chosen from hydrocarbons and chlorofluorocarbons. Preferably the blowing agent is chosen from pentane, propane, methylene chloride, pentane, isopentane, cyclopentane, methylene chloride, and liquid CO₂. “EPS” according to the present invention may either be essentially only expanded polystyrene with naturally occurring impurities, or optionally may also include mixtures of other recycled materials and other forms of PS and Polypropylene (PP).

In one embodiment of the present invention the A polystyrene sheet can be formed from extruded EPS which is cut into a desired size, for example 4×6, 5×7, 8×10, or 10×14. The thickness of the sheets may be any desired size, for example from 1 mm to 25 mm, or any size there between, including 1-2 mm, 1-5 mm, 1-10 mm, 1-20 mm, 1-25 mm, 5-20 mm, 5-15 mm, 5-10 mm. The sheets can have images printed on any surface thereof and may have multiple images printed on multiple surfaces. Furthermore, as the sheets are penetrable they may be decorated on either the sides or the face of the sheet itself with various decorative materials. Such materials may be selected from, but are not limited to, for example, edge bands with plastic trims, decorative garlands, rope/cord for nautical themes, LED light strips, large upholstery tacks, decorative ribbons, fishing lures for fishing themes, or souvenir pins with logos of various professional and college teams.

In one embodiment according to the present invention the process of forming a polystyrene recycled sheet may be as follows and as illustrated in FIG. 1. Discarded EPS (1a, 1b) may be densified by a densifier (2) to produce densified EPS. “Densified EPS” means that the compaction ratio is of 50:1 up to 80:1 depending on the size of the expanded EPS bead in the discarded article. Preferably, densified EPS in the 23-26 lbs/cubic foot range. The densifier may be a cold press which uses hydraulic pressure to squeeze the trapped air out of the discarded EPS to produce a block or log of densified EPS, or a thermal machine which uses both heat and pressure to densify the discarded EPS. The cold press may be, for example, Model D-120° from the Sebright Products Company. The densified EPS may then be formed into EPS pellets (3) with, for example, a commercial pelletizer such as the NGR Pelletizer NGR X-Gran 185°. The EPS pellets are then extruded and formed into sheets (4). The extruded sheets then may be cut into the desired sizes (5). The extrusion process may be adjusted to control the final size and quality of the product. The sheets will have a naturally white color suited for printing digital images. However, if desired, the sheets may be further died to cover impurities, or died to alternative colors. The sheets may then be cut into desired sizes, for example 4×6, 5×7, 8×10, or 10×14. The thickness of the sheets may be any desired size, for example from 1 mm to 25 mm, or any size there between, including 1-2 mm, 1-5 mm, 1-10 mm, 1-20 mm, 1-25 mm, 5-20 mm, 5-15 mm, 5-10 mm. As polystyrene sheets have substantially low density, large thick sheets may be formed which have low mass and are easily affixable to walls. The waste trim left over after the sheets are cut may then be recycled back into the original batch of densified EPS.

The cut sheets may then be affixed with digital images (9). The affixing may be performed by any process known in the art, for example inkjet printers or dye-sublimation printers (6). The cut sheets (7a, 7b) may then optionally be decorated around the edges with various decorative materials (8) to enhance the image. Such materials may be selected from, but are not limited to, for example, edge bands with plastic trims, decorative garlands, rope/cord for nautical themes, LED light strips, large upholstery tacks, decorative ribbons, fishing lures for fishing themes, or souvenir pins with logos representing various professional and college teams. The decorative materials may cover a plurality of surfaces of the sheet, preferably the side, top and bottom surfaces of the sheet, or any fraction thereof (10).

Although the sheet may be rectangular or square, it may also be fabricated into various other shapes to enhance the image displayed thereon. For example, the sheet may be shaped into the size of the object printed, to circles, ovals, triangles, and to mirror the size of any desired item by a cutting tool, such as a reciprocating knife, blade or saw. Due to the low density of the sheets, it is easy to cut and manipulate the shape of the sheets. This provides an advantage for the consumer over conventional wood frames and canvas prints.

A polystyrene sheet can be naturally white, but may be died to correct impurities or to change the original color. State of the art pigments may be used and cured by UV light to ensure that the colors will not fade over time. These pigments can also impart scratch resistance to the image surface. This eliminates the need for protective glass sheets and substantially reduces mass of the final product. This becomes especially important when the consumer desires large image sizes for mounting.

In another process the EPS logs are fed into a recycling machine where they are broken down, and automatically fed into an extruder which heats the material beyond its melting point. EPS has a melting point of approximately 110° C. and thus is relatively easy to heat and manipulate. The “plasticized” material is then fed through a screen, the gases vented, and the pellets can be made. During this process, a white color master batch can be added to aid in making the finished pellets as white as possible. This step “masks” any dirt and impurities which made it into the extruder. The resulting pellets are then fed into a “sheet extruder” with a sheet die attached in order to form an expanded thermoplastic sheet. All three dimensions (x, y, z) can be adjusted to alter the finished product. A suitable blowing agent can be added, such as CO₂ or pentane, in order to create a tight closed cell foam in the finished sheet. This enables the consumer to have the option of adhering decorative boarders to either the edges or face of the sheet with push pins, staples, or adhesives.

An EPS material which can be formed into densified EPS is preferably discarded polystyrene. As such, the entire process may be performed at a consumer facility that produces polystyrene waste. This closed process can eliminate a need for recycling facilities and transportation to move the polystyrene and will in turn help eliminate polystyrene pollution. Furthermore, the polystyrene foamed sheet itself may be recycled back into the original EPS batch. As such, the overall process can be a cyclical closed loop recycling process.

Polystyrene sheets address problems associated with traditional framing. Specifically, consumers can be provided with a much more cost effective way to display digital photos, artwork, and other articles over traditional framing, which encompasses cutting of frame stock, matting, and glass.

Furthermore, because the border of the invention is a tight cellular foamed plastic, the consumer can affix a wide variety of decorative objects by pushing pins or staples into the polystyrene sheet, self adhesive tapes, or various glues. This gives the consumer the ability to change the look or appearance of their photos, artwork, and displayed articles. With traditional bulky wood and metal frames, once the article is on the wall it becomes a “static” fixture over time.

The recycled EPS pellets may also be compression molded to form a near net shape three dimensional article. The compression molding may be performed by a process of Nickel Vapor Deposition (NVD) which creates a grain or texture to the mold. This mold has the look, feel and appearance of wood or another grainy substance. When the image is affixed to the mold, the background realistically simulates wood and/or natural grains.

The processes described above may be executed in whole or in part by one or more processing systems. The one or more processing systems can be connected directly, or through a network, to a cutter (e.g., a cutting tool) and a printer (e.g., an ink jet printer) and can send corresponding signals to the cutter and the printer as part of a manufacturing process for manufacturing a polystyrene sheet that includes one or more images printed thereon. The one or more processing systems may be connected directly, or through a network, to other systems or devices that are related to the manufacturing process, including a pellet forming machine, a heater, a conveyer system, and an ultraviolet light irradiation system.

FIG. 4 illustrates an exemplary processing system in accordance with this disclosure that can be implemented using a microprocessor or its equivalent, such as a central processing unit (CPU) and/or at least one application specific processor ASP (not shown). The microprocessor is a circuit that includes circuitry that utilizes a computer readable storage medium, such as a memory circuit (e.g., ROM, EPROM, EEPROM, flash memory, static memory, DRAM, SDRAM, and their equivalents), configured to control the microprocessor to perform and/or control the processes and systems of this disclosure. Other storage mediums can be controlled via a controller, such as a disk controller, which can controls a hard disk drive or optical disk drive.

The microprocessor or aspects thereof, in alternate implementations, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The microprocessor can be a separate device or a single processing mechanism. Further, this disclosure can benefit from parallel processing capabilities of a multi-cored CPU.

In another aspect, results of processing in accordance with this disclosure can be displayed via a display controller to a monitor. The display controller preferably includes at least one graphic processing unit, which can be provided by a plurality of graphics processing cores, for improved computational efficiency. Additionally, an I/O (input/output) interface is provided for inputting signals and/or data from microphones, speakers, cameras, a mouse, a keyboard, a touch-based display or pad interface, etc., which can be connected to the I/O interface as a peripheral. For example, a keyboard or a pointing device for controlling parameters of the various processes and algorithms of this disclosure can be connected to the I/O interface to provide additional functionality and configuration options, or control display characteristics. Moreover, the monitor can be provided with a touch-sensitive interface for providing a command/instruction interface.

The above-noted components can be coupled to a network, such as the Internet or a local intranet, via a network interface for the transmission or reception of data, including controllable parameters. A central BUS is provided to connect the above hardware components together and provides at least one path for digital communication there between.

The procedures and routines described herein can be embodied as a system, method or computer program product, and can be executed via one or more dedicated circuits or programmed processors. Accordingly, the descriptions provided herein may take the form of exclusively hardware, exclusively software executed on hardware (including firmware, resident software, micro-code, etc.), or through a combination of dedicated hardware components and general processors that are configured by specific algorithms and process codes. Hardware components are referred to as a “circuit,” “module,” “unit,” “device,” or “system.” Executable code that is executed by hardware is embodied on a tangible memory device, such as a computer program product. Examples include CDs, DVDs, flash drives, hard disk units, ROMs, RAMs and other memory devices.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

The above written description of the invention provides a manner and process of making and using it such that any person skilled in this art is enabled to make and use the same, this enablement being provided in particular for the subject matter of the appended claims, which make up a part of the original description.

As used herein, the words “a” and “an” and the like carry the meaning of “one or more.”

The phrases “selected from the group consisting of,” “chosen from,” and the like include mixtures of the specified materials. Terms such as “contain(s)” and the like are open terms meaning ‘including at least’ unless otherwise specifically noted.

All references, patents, applications, tests, standards, documents, publications, brochures, texts, articles, etc. mentioned herein are incorporated herein by reference. Where a numerical limit or range is stated, the endpoints are included unless specified otherwise. Also, all values and sub-ranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A process of producing a polystyrene sheet formed of recycled polystyrene, said process comprising:
densifying discarded EPS to produce densified expanded polystyrene,
converting the densified expanded polystyrene into pellets,
extruding the pellets into a sheet,
cutting the sheet to a desired size,
and affixing an image to at least one surface of the sheet.

2. The process of claim 1, wherein the waste produced when the sheet is cut is recycled back into the discarded expanded polystyrene.

3. The process of claim 1, wherein the extruder is adjusted to obtain a thickness of the finished sheet from 1 mm to 25 mm.

4. The process of claim 1, wherein the image is affixed with an inkjet printer or a dye-sublimation printer.

5. The process of claim 1, wherein the sheet is further decorated on at least one surface thereof with a decorative material.

6. The process of claim 5, wherein the decorative material is at least one selected from the group consisting of an edge band, a decorative garland, a rope, a cord, an LED light strip, a large upholstery tack, a decorative ribbon, a fishing lure, or souvenir pins with logos representing professional or college sports teams.

7. The process of claim 1, wherein the sheet may be died with a pigment and cured by UV light.

8. A process of producing a polystyrene sheet formed of recycled polystyrene, said process comprising:
densifying discarded expanded polystyrene to produce densified expanded polystyrene,
breaking down the densified EPS to form pellets,
feeding the pellets into an extruder,
heating the pellets beyond its melting point to form plasticized expanded polystyrene, wherein during said heating a white color master batch is added to the pellets,
feeding the plasticized EPS through a screen to form secondary pellets,
feeding the secondary pellets into a sheet extruder with a sheet die to form an expanded thermoplastic sheet.

9. The process of claim 8, wherein a blowing agent is added.

10. The process of claim 8, wherein the sheet is further decorated on at least one surface thereof with a decorative material.

11. A polystyrene sheet formed by the process of claim 1.

12. A polystyrene sheet formed by the process of claim 8.

13. A polystyrene sheet formed of recycled polystyrene, said polystyrene sheet being affixed with at least one image on a primary surface thereof.

14. The polystyrene sheet formed of recycled polystyrene according to claim 13, wherein the image may wrap from the primary surface to a secondary surface.

15. The polystyrene sheet formed of recycled polystyrene according to claim 13, wherein a decorative material is affixed to at least one surface of the polystyrene sheet.

16. The polystyrene sheet formed of recycled polystyrene according to claim 15, wherein said decorative material is affixed with at least one item selected from the group consisting of adhesive, a push pin, a staple, a nail, or tape.

17. The polystyrene sheet formed of recycled polystyrene according to claim 13, wherein the polystyrene sheet is cut into a non-rectangular shape.

18. The polystyrene sheet formed of recycled polystyrene according to claim 13, wherein the recycled polystyrene is UV cured.

19. The polystyrene sheet formed of recycled polystyrene according to claim 13, wherein the recycled polystyrene is expanded polystyrene.

20. The polystyrene sheet formed of recycled polystyrene according to claim 13, wherein the recycled polystyrene is expanded polystyrene comprises mixtures of other recycled materials and other forms of expanded polystyrene and Polypropylene.
